(19) United States
(12) Patent Application Publication
(10) Pub. No.: US 2026/0029938 A1
(43) Pub. Date: Jan. 29, 2026

(54) INDEPENDENT PARALLEL PLANE ACCESS TO IMPROVE BOOTUP LATENCY IN A MULTI-PLANE MEMORY DEVICE

(71) Applicant: Micron Technology, Inc., Boise, ID (US)

(72) Inventors: Deping He, Boise, ID (US); Xing Wang, Shanghai (CN); Qisong Lin, El Dorado Hills, CA (US)

(21) Appl. No.: 19/281,432

(22) Filed: Jul. 25, 2025

Related U.S. Application Data
(60) Provisional application No. 63/676,843, filed on Jul. 29, 2024.

(51) Int. Cl. G06F 3/06

(52) U.S. Cl. CPC G06F 3/0632; G06F 3/0611; G06F 3/0679

(57) ABSTRACT

A memory sub-system includes a memory device comprising a memory array comprising a plurality of planes a processing device configured to detect a boot process of the system subsequent to an occurrence of a power loss event, and initiate a series of multi-plane read operations to identify a last written page of the memory device, wherein the last written page was programmed prior to the occurrence of the power loss event, and wherein at least a portion of the memory device remains unprogrammed.

### RELATED APPLICATIONS

This application claims the benefit of priority from U.S. Provisional Patent Application No. 63/676,843, filed Jul. 29, 2024, the entire contents of which are hereby incorporated by reference herein.

### TECHNICAL FIELD

Embodiments of the disclosure relate generally to memory sub-systems, and more specifically, relate to independent parallel plane access to improve bootup latency in a multi-plane memory device in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing system that includes a memory sub-system in accordance with some embodiments of the present disclosure.

FIG. 1B is a block diagram of a memory device in communication with a memory sub-system controller of a memory sub-system in accordance with some embodiments of the present disclosure.

FIG. 2 is a schematic of portions of an array of memory cells as could be used in a memory of the type described with reference to FIG. 1B in accordance with some embodiments of the present disclosure.

FIG. 3 is a block diagram illustrating a multi-plane memory device configured for independent parallel plane access in accordance with some embodiments of the present disclosure.

FIG. 4 is a flow diagram of an example method of performing a series of multi-plane read operations to identify a last written page in a multi-plane memory device in accordance with some embodiments of the present disclosure.

FIG. 5A and FIG. 5B are block diagrams illustrating the use of independent parallel plane access to identify a last written page in a multi-plane memory device using a series of multi-plane read operations in accordance with some embodiments of the present disclosure.

FIG. 6 is a block diagram of an example computer system in which embodiments of the present disclosure can operate.

### DETAILED DESCRIPTION

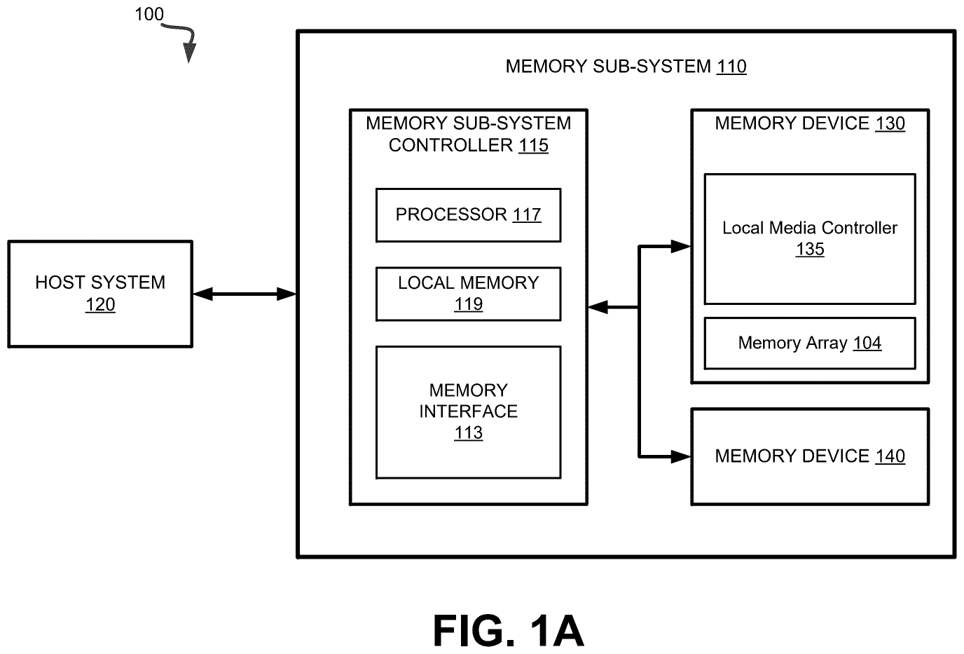

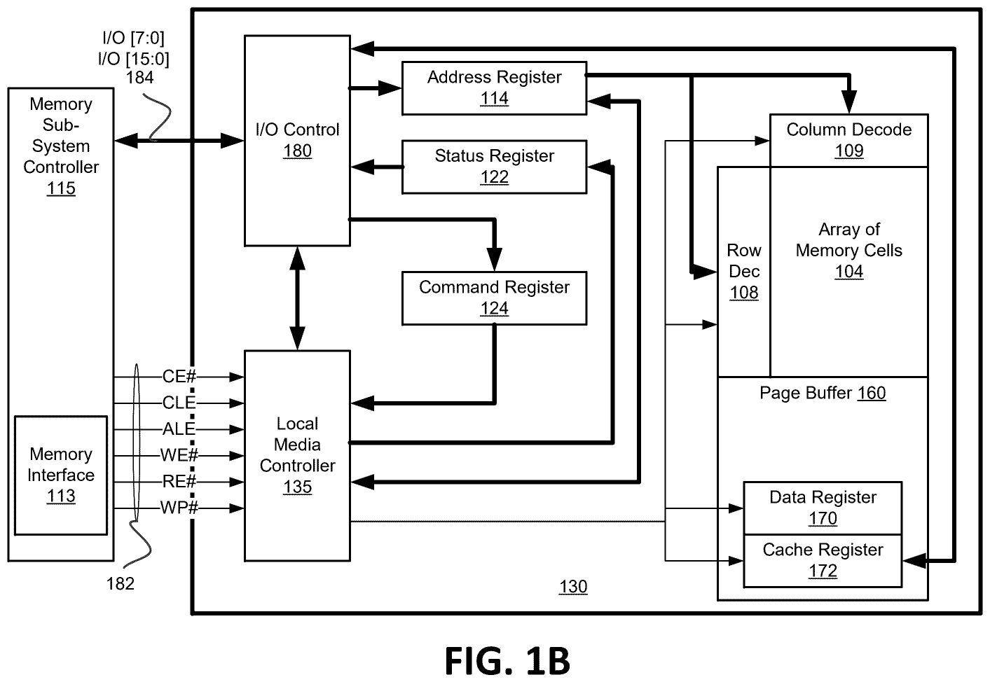

Aspects of the present disclosure are directed to independent parallel plane access to improve bootup latency in a multi-plane memory device in a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits.

In many memory sub-systems, particularly those used in mobile or automotive implementations, bootup latency is a key performance metric. When restarting after a planned power-down or a sudden power loss event, the memory sub-system must establish the last written page in each block of the memory device so that previous programming operations can be resumed and/or new programming operations can be initiated at the proper location on the memory device. As the last written page is not tracked in the event of power loss, the memory sub-system can perform a search operation to determine the last written page. Certain memory sub-systems utilize a binary search method of reading either random pages or selected pages in a predefined pattern to determine whether those pages have been written or not. Given that pages in each block are programmed in a sequential order, depending on whether the read pages are programmed or not, the memory sub-system can next read either a previous or a subsequent page. This process can be repeated, often through a number of iterations, until the last written page is identified. In modern memory sub-systems, there are often numerous different types of blocks, each of which must be similarly searched to identify the respective last written pages. These types of blocks can include, for example, system blocks, flash translation layer blocks, garbage collection blocks, host single-level cell (SLC) blocks, host triple-level cell (TLC) or quad-level cell (QLC) blocks, etc. In addition, as the number of pages (i.e., wordlines) in each block grows in new memory sub-system generations, the latency associated with identifying the last written page can quickly surpass permissible quality of service requirements associated with the bootup process.

Aspects of the present disclosure address the above and other deficiencies by utilizing independent parallel plane access to improve bootup latency in a multi-plane memory device in a memory sub-system. In a memory device with independent plane driver circuits, a multi-plane read operation can be performed to decrease the latency associated with identifying the last written page of a block after bootup of the memory device. For example, in a memory device with four independent planes, the memory sub-system can initiate a read operation of a different page on each of the planes. The different pages can be strategically selected to decrease the number of iterations that will be needed to identify the last written page. For example, if the memory device has 40 pages (i.e., wordlines) per block, in a first read operation, the memory sub-system can read page 8 from the first plane, page 16 from the second plane, page 24 from the third plane, and page 32 from the fourth plane. If the memory sub-system determines that at least one of those pages has not been programmed, the memory sub-system can perform a second multi-plane read operation using different pages on the multiple planes that fall between the page that was determined not to have been programmed in the first multi-plane read operation and the previous page that was determined to have been programmed in the first multi-plane read operation. For example, if page 16 was programmed, but page 24 was not programmed but, in the second multi-plane read operation, the memory sub-system could read page 18 from the first plane, page 20 from the second plane, page 22 from the third plane, and page 23 from the fourth plane. This process can be repeated until the last written page for the block is identified.

In another embodiment, the same multi-plane read operation can be applied across multiple blocks. For example, the memory sub-system can read a page from a different plane of each of four different blocks in one read operation. The results of such a multi-plane read operation can be used to focus subsequent read operations performed separately on each different block in order to identify the respective last written pages.

Advantages of this approach include, but are not limited to, improved performance in the memory sub-system. The latency associated with determining the last written page for each block in the memory sub-system can be significantly reduced (e.g., by 2× or more) compared to conventional binary search approaches. This reduces the overall time of the bootup process and improves the quality of service for the host system utilizing the memory sub-system.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., memory devices 130) when the memory sub-system 110 is coupled with the host system 120 by the physical host interface (e.g., PCIe or CXL interface). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include not-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device 130 having control logic (e.g., local controller 135) on the die and a controller (e.g., memory sub-system controller 115) for media management within the same memory device package. An example of a managed memory device is a managed NAND (MNAND) device. Memory device 130, for example, can represent a single die having some control logic (e.g., local media controller 135) embodied thereon. In some embodiments, one or more components of memory sub-system 110 can be omitted.

In one embodiment, the memory sub-system 110 includes a memory interface 113 that is responsible for handling interactions of memory sub-system controller 115 with the memory devices of memory sub-system 110, such as memory device 130. For example, the memory interface 113 can send memory access commands corresponding to requests received from host system 120 to memory device 130, such as program commands, read commands, or other commands. In addition, the memory interface 113 can receive data from memory device 130, such as data retrieved in response to a read command or a confirmation that a program command was successfully performed. In some embodiments, the memory sub-system controller 115 includes at least a portion of the memory interface 113. For example, the memory sub-system controller 115 can include a processor 117 (processing device) configured to execute instructions stored in local memory 119 for performing the operations described herein.

In one embodiment, responsive to a boot-up of memory sub-system 110, memory interface 113 can initiate a multi-plane read operation utilizing independent parallel plane access to identify a last written page, or other segment, in memory array 104 of memory device 130. For example, memory interface 113 can send one or more commands to local media controller 135 of memory device 130 to cause local media controller 135 to perform the multi-plane read operation. In one embodiment, the memory array 104 of memory device 130 is arranged into multiple planes (e.g., four planes), as will be described in more detail below. Each plane has corresponding independent plane driver circuits which permit different segments of each plane to be read concurrently (i.e., at least partially overlapping in time) in a single memory access operation. For example, the commands from memory interface 113 can cause local media controller 135 to initiate a read operation of a different segment (e.g., page) on each of the planes in memory array 104. The different segments can be strategically selected to decrease the number of iterations that will be needed to identify the last written page. Further details with regards to the operations of memory interface 113 and local media controller 135 are described below.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device. In one embodiment, memory sub-system controller 115 includes memory interface 113.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bit line). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 109 are provided to decode address signals. Address signals are received and decoded to access the array of memory cells 104. Memory device 130 also includes input/output (I/O) control circuitry 180 to manage input of commands, addresses and data to the memory device 130 as well as output of data and status information from the memory device 130. An address register 114 is in communication with I/O control circuitry 180 and row decode circuitry 108 and column decode circuitry 109 to latch the address signals prior to decoding. A command register 124 is in communication with I/O control circuitry 180 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 109 to control the row decode circuitry 108 and column decode circuitry 109 in response to the addresses.

The local media controller 135 is also in communication with a cache register 172. Cache register 172 latches data, either incoming or outgoing, as directed by the local media controller 135 to temporarily store data while the array of memory cells 104 is busy writing or reading, respectively, other data. During a program operation (e.g., write operation), data may be passed from the cache register 172 to the data register 170 for transfer to the array of memory cells 104; then new data may be latched in the cache register 172 from the I/O control circuitry 180. During a read operation, data may be passed from the cache register 172 to the I/O control circuitry 180 for output to the memory sub-system controller 115; then new data may be passed from the data register 170 to the cache register 172. The cache register 172 and/or the data register 170 may form (e.g., may form a portion of) a page buffer 160 of the memory device 130. The page buffer 160 may further include sensing devices (not shown in FIG. 1B) to sense a data state of a memory cell of the array of memory cells 104 (e.g., by sensing a state of a data line connected to that memory cell). A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 182. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 182 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 184 and outputs data to the memory sub-system controller 115 over I/O bus 184.

For example, the commands may be received over input/output (I/O) pins [7:0] of I/O bus 184 at I/O control circuitry 180 and may then be written into command register 124. The addresses may be received over input/output (I/O) pins [7:0] of I/O bus 184 at I/O control circuitry 180 and may then be written into address register 114. The data may be received over input/output (I/O) pins [7:0] for an 8-bit device or input/output (I/O) pins [15:0] for a 16-bit device at I/O control circuitry 180 and then may be written into cache register 172. The data may be subsequently written into data register 170 for programming the array of memory cells 104.

In an embodiment, cache register 172 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

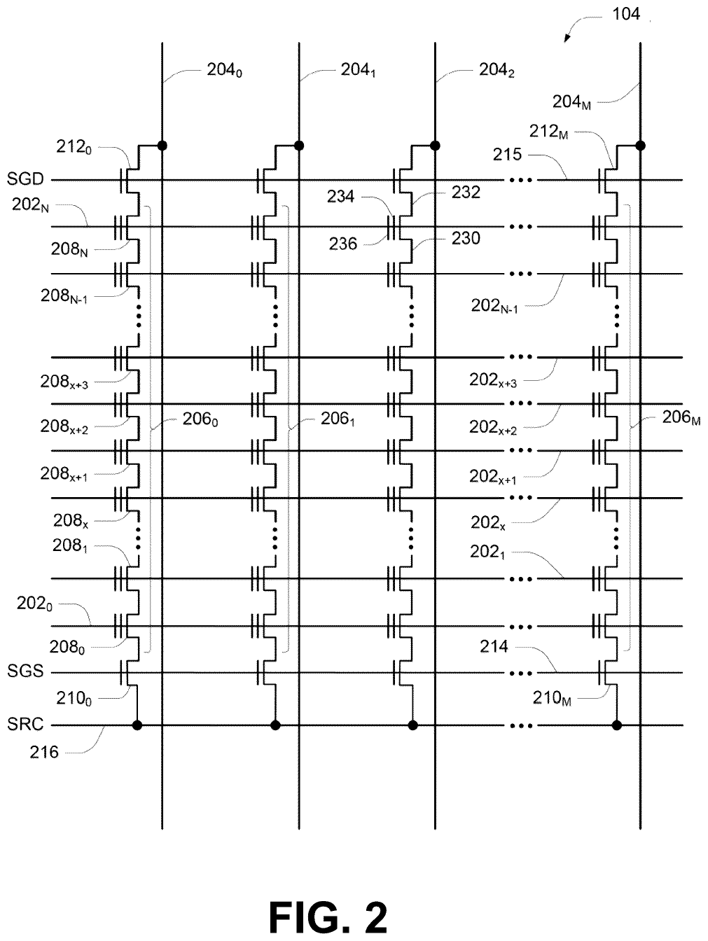

FIG. 2 is a schematic of portions of an array of memory cells 104, such as a NAND memory array, as could be used in a memory of the type described with reference to FIG. 1B according to an embodiment. Memory array 104 includes access lines, such as wordlines 202₀ to 202_{N}, and data lines, such as bit lines 204₀ to 204_{M}. The wordlines 202 can be connected to global access lines (e.g., global wordlines), not shown in FIG. 2, in a many-to-one relationship. For some embodiments, memory array 104 can be formed over a semiconductor that, for example, can be conductively doped to have a conductivity type, such as a p-type conductivity, e.g., to form a p-well, or an n-type conductivity, e.g., to form an n-well.

Memory array 104 can be arranged in rows (each corresponding to a wordline 202) and columns (each corresponding to a bit line 204). Each column can include a string of series-connected memory cells (e.g., non-volatile memory cells), such as one of NAND strings 206₀ to 206_{M}. Each NAND string 206 can be connected (e.g., selectively connected) to a common source (SRC) 216 and can include memory cells 208₀ to 208_{N}. The memory cells 208 can represent non-volatile memory cells for storage of data. The memory cells 208 of each NAND string 206 can be connected in series between a select gate 210 (e.g., a field-effect transistor), such as one of the select gates 210₀ to 210_{M} (e.g., that can be source select transistors, commonly referred to as select gate source), and a select gate 212 (e.g., a field-effect transistor), such as one of the select gates 212₀ to 212_{M} (e.g., that can be drain select transistors, commonly referred to as select gate drain). Select gates 210₀ to 210_{M} can be commonly connected to a select line 214, such as a source select line (SGS), and select gates 212₀ to 212_{M} can be commonly connected to a select line 215, such as a drain select line (SGD). Although depicted as traditional field-effect transistors, the select gates 210 and 212 can utilize a structure similar to (e.g., the same as) the memory cells 208. The select gates 210 and 212 can represent a number of select gates connected in series, with each select gate in series configured to receive a same or independent control signal.

A source of each select gate 210 can be connected to common source 216. The drain of each select gate 210 can be connected to a memory cell 208₀ of the corresponding NAND string 206. For example, the drain of select gate 210₀ can be connected to memory cell 208₀ of the corresponding NAND string 206₀. Therefore, each select gate 210 can be configured to selectively connect a corresponding NAND string 206 to the common source 216. A control gate of each select gate 210 can be connected to the select line 214.

The drain of each select gate 212 can be connected to the bit line 204 for the corresponding NAND string 206. For example, the drain of select gate 212₀ can be connected to the bit line 204₀ for the corresponding NAND string 206₀. The source of each select gate 212 can be connected to a memory cell 208_{N} of the corresponding NAND string 206. For example, the source of select gate 212₀ can be connected to memory cell 208_{N} of the corresponding NAND string 206₀. Therefore, each select gate 212 can be configured to selectively connect a corresponding NAND string 206 to the corresponding bit line 204. A control gate of each select gate 212 can be connected to select line 215.

The memory array 104 in FIG. 2 can be a quasi-two-dimensional memory array and can have a generally planar structure, e.g., where the common source 216, NAND strings 206 and bit lines 204 extend in substantially parallel planes. Alternatively, the memory array 104 in FIG. 2 can be a three-dimensional memory array, e.g., where NAND strings 206 can extend substantially perpendicular to a plane containing the common source 216 and to a plane containing the bit lines 204 that can be substantially parallel to the plane containing the common source 216.

Typical construction of memory cells 208 includes a data-storage structure 234 (e.g., a floating gate, charge trap, and the like) that can determine a data state of the memory cell (e.g., through changes in threshold voltage), and a control gate 236, as shown in FIG. 2. The data-storage structure 234 can include both conductive and dielectric structures while the control gate 236 is generally formed of one or more conductive materials. In some cases, memory cells 208 can further have a defined source/drain (e.g., source) 230 and a defined source/drain (e.g., drain) 232. The memory cells 208 have their control gates 236 connected to (and in some cases form) a wordline 202.

A column of the memory cells 208 can be a NAND string 206 or a number of NAND strings 206 selectively connected to a given bit line 204. A row of the memory cells 208 can be memory cells 208 commonly connected to a given wordline 202. A row of memory cells 208 can, but need not, include all the memory cells 208 commonly connected to a given wordline 202. Rows of the memory cells 208 can often be divided into one or more groups of physical pages of memory cells 208, and physical pages of the memory cells 208 often include every other memory cell 208 commonly connected to a given wordline 202. For example, the memory cells 208 commonly connected to wordline 202_{N} and selectively connected to even bit lines 204 (e.g., bit lines 204₀, 204₂, 204₄, etc.) can be one physical page of the memory cells 208 (e.g., even memory cells) while memory cells 208 commonly connected to wordline 202_{N} and selectively connected to odd bit lines 204 (e.g., bit lines 204₁, 204₃, 204₅, etc.) can be another physical page of the memory cells 208 (e.g., odd memory cells).

Although bit lines 204₃-204₅ are not explicitly depicted in FIG. 2, it is apparent from the figure that the bit lines 204 of the array of memory cells 104 can be numbered consecutively from bit line 204₀ to bit line 204_{M}. Other groupings of the memory cells 208 commonly connected to a given wordline 202 can also define a physical page of memory cells 208. For certain memory devices, all memory cells commonly connected to a given wordline can be deemed a physical page of memory cells. The portion of a physical page of memory cells (which, in some embodiments, could still be the entire row) that is read during a single read operation or programmed during a single programming operation (e.g., an upper or lower page of memory cells) can be deemed a logical page of memory cells. A block of memory cells can include those memory cells that are configured to be erased together, such as all memory cells connected to wordlines 202₀-202_{N} (e.g., all NAND strings 206 sharing common wordlines 202). Unless expressly distinguished, a reference to a page of memory cells herein refers to the memory cells of a logical page of memory cells. Although the example of FIG. 2 is discussed in conjunction with NAND flash, the embodiments and concepts described herein are not limited to a particular array architecture or structure, and can include other structures (e.g., SONOS, phase change, ferroelectric, etc.) and other architectures (e.g., AND arrays, NOR arrays, etc.).

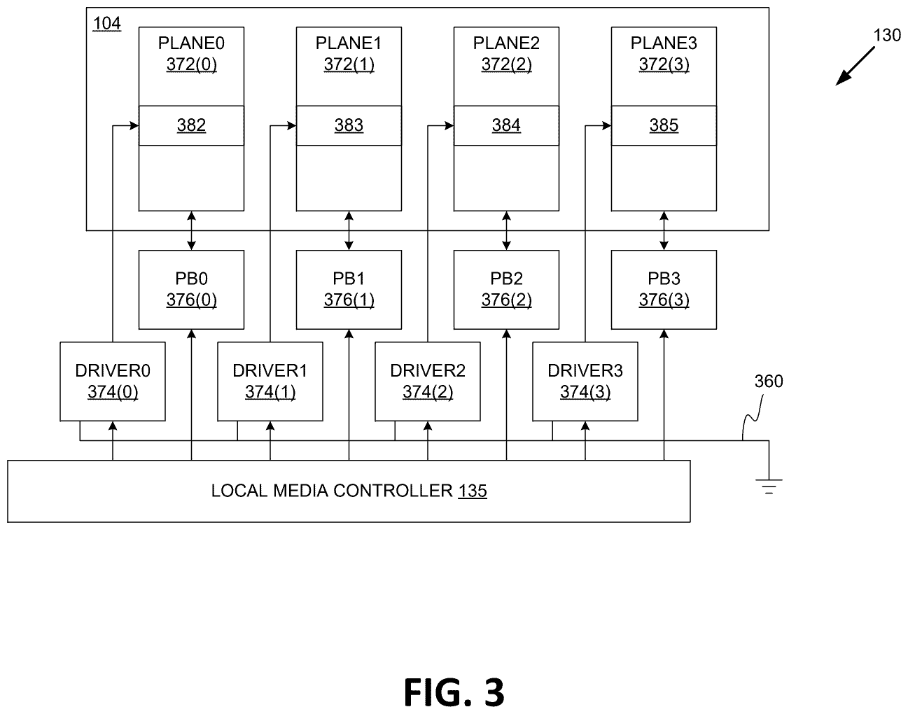

FIG. 3 is a block diagram illustrating a multi-plane memory device configured for independent parallel plane access in accordance with some embodiments of the present disclosure. The memory planes 372(0)-372(3) can each be divided into segments (e.g., blocks or pages) of data, with a different relative segment of data from two or more of the memory planes 372(0)-372(3) concurrently accessible during memory access operations. For example, during memory access operations, two or more of segment 382 of the memory plane 372(0), segment 383 of the memory plane 372(1), segment 384 of the memory plane 372(2), and segment 385 of the memory plane 372(3) can each be accessed concurrently. In one embodiment, each of segments 382-385 represent different pages (i.e., memory cells associated with different wordlines in memory array 104) that can be read concurrently as part of a multi-plane read operation to identify a last written page in the memory array 104 after a power loss event.

The memory device 130 includes a memory array 104 divided into memory planes 372(0)-372(3) that each includes a respective number of memory cells. The multi-plane memory device 130 can further include local media controller 135, including a power control circuit and access control circuit for concurrently performing memory access operations for different memory planes 372(0)-372(3). The memory cells can be non-volatile memory cells, such as NAND flash cells, or can generally be any type of memory cells.

The memory planes 372(0)-372(3) can each be divided into blocks of data, with a different segment of data (e.g., block or page) from each of the memory planes 372(0)-372(3) concurrently accessible during memory access operations. For example, during memory access operations, segment 382 of the memory plane 372(0), segment 383 of the memory plane 372(1), segment 384 of the memory plane 372(2), and segment 385 of the memory plane 372(3) can each be accessed concurrently.

Each of the memory planes 372(0)-372(3) can be coupled to a respective page buffer 376(0)-376(3). Each page buffer 376(0)-376(3) can be configured to provide data to or receive data from the respective memory plane 372(0)-372(3). The page buffers 376(0)-376(3) can be controlled by local media controller 135. Data received from the respective memory plane 372(0)-372(3) can be latched at the page buffers 376(0)-376(3), respectively, and retrieved by local media controller 135, and provided to the memory sub-system controller 115 via the NVMe interface.

Each of the memory planes 372(0)-372(3) can be further coupled to a respective access driver circuit 374(0)-374(3), such as an access line driver circuit. The driver circuits 374(0)-374(3) can be configured to condition a page of a respective block of an associated memory plane 372(0)-372(3) for a memory access operation, such as programming data (i.e., writing data), reading data, or erasing data. Each of the driver circuits 374(0)-374(3) can be coupled to a respective global access lines associated with a respective memory plane 372(0)-372(3). Each of the global access lines can be selectively coupled to respective local access lines within a block of a plane during a memory access operation associated with a page within the block. The driver circuits 374(0)-374(3) can be controlled based on signals from local media controller 135. Each of the driver circuits 374(0)-374(3) can include or be coupled to a respective power circuit, and can provide voltages to respective access lines based on voltages provided by the respective power circuit. The voltages provided by the power circuits can be based on signals received from local media controller 135.

The local media controller 135 can control the driver circuits 374(0)-374(3) and page buffers 376(0)-376(3) to concurrently perform memory access operations associated with each of a group of memory command and address pairs (e.g., received from memory sub-system controller 115). For example, local media controller 135 can control the driver circuits 374(0)-374(3) and page buffer 376(0)-376(3) to perform the concurrent memory access operations. Local media controller 135 can include a power control circuit that serially configures two or more of the driver circuits 374(0)-374(3) for the concurrent memory access operations, and an access control circuit configured to control two or more of the page buffers 376(0)-376(3) to sense and latch data from the respective memory planes 372(0)-372(3), or program data to the respective memory planes 372(0)-372(3) to perform the concurrent memory access operations.

In operation, local media controller 135 can receive a group of memory command and address pairs via the NVMe bus, with each pair arriving in parallel or serially. In some examples, the group of memory command and address pairs can each be associated with different respective memory planes 372(0)-372(3) of the memory array 104. The local media controller 135 can be configured to perform concurrent memory access operations (e.g., read operations or program operations) for the different memory planes 372(0)-372(3) of the memory array 104 responsive to the group of memory command and address pairs. For example, the power control circuit of local media controller 135 can serially configure, for the concurrent memory access operations based on respective page type (e.g., UP, MP, LP, XP, SLC/MLC/TLC/QLC page), the driver circuits 374(0)-374(3) for two or more memory planes 372(0)-372(3) associated with the group of memory command and address pairs. After the access line driver circuits 374(0)-374(3) have been configured, the access control circuit of local media controller 135 can concurrently control the page buffers 376(0)-376(3) to access the respective pages of each of the two or more memory planes 372(0)-372(3) associated with the group of memory command and address pairs, such as retrieving data or writing data, during the concurrent memory access operations. For example, the access control circuit can concurrently (e.g., in parallel and/or contemporaneously) control the page buffers 376(0)-376(3) to charge/discharge bitlines, sense data from the two or more memory planes 372(0)-372(3), and/or latch the data.

Based on the signals received from local media controller 135, the driver circuits 374(0)-374(3) that are coupled to the memory planes 372(0)-372(3) associated with the group of memory command and address command pairs can select blocks of memory or memory cells from the associated memory plane 372(0)-372(3), for memory operations, such as read, program, and/or erase operations. The driver circuits 374(0)-374(3) can drive different respective global access lines associated with a respective memory plane 372(0)-372(3). As an example, the driver circuit 374(0) can drive a first voltage on a first global access line associated with the memory plane 372(0), the driver circuit 374(1) can drive a second voltage on a third global access line associated with the memory plane 372(1), the driver circuit 374(2) can drive a third voltage on a seventh global access line associated with the memory plane 372(2), etc., and other voltages can be driven on each of the remaining global access lines. In some examples, pass voltages can be provided on all access lines except an access line associated with a page of a memory plane 372(0)-372(3) to be accessed. The local media controller 135, the driver circuits 374(0)-374(3) can allow different respective pages, and the page buffers 376(0)-376(3) within different respective blocks of memory cells, to be accessed concurrently. For example, a first page of a first block of a first memory plane can be accessed concurrently with a second page of a second block of a second memory plane, regardless of page type.

The page buffers 376(0)-376(3) can provide data to or receive data from the local media controller 135 during the memory access operations responsive to signals from the local media controller 135 and the respective memory planes 372(0)-372(3). The local media controller 135 can provide the received data to memory sub-system controller 115.

It will be appreciated that the memory device 130 can include more or less than four memory planes, driver circuits, and page buffers. It will also be appreciated that the respective global access lines can include 8, 16, 32, 64, 128, etc., global access lines. The local media controller 135 and the driver circuits 374(0)-374(3) can concurrently access different respective pages within different respective blocks of different memory planes when the different respective pages are of a different page type. In another embodiment, memory device 130 can include fewer driver circuits than there are planes. In such an embodiment, memory device 130 can further includes a plane selection circuit (e.g., a number of bi-directional multiplexer circuits) controlled by control signals received from local media controller 135. The plane selection circuit allows any of the driver circuits to be selectively coupled to any of the memory planes in memory device 130. In this manner, there is not a fixed association between any of the driver circuits and any of the planes.

In one embodiment, driver circuits 374(0)-374(3) share a common voltage supply line 360. Depending on the embodiment, common voltage supply line 360 can provide a positive voltage signal, a negative voltage signal, or a ground voltage signal to driver circuits 374(0)-374(3) to enable operation of certain components, such as nMOS transistors, within driver circuits 374(0)-374(3).

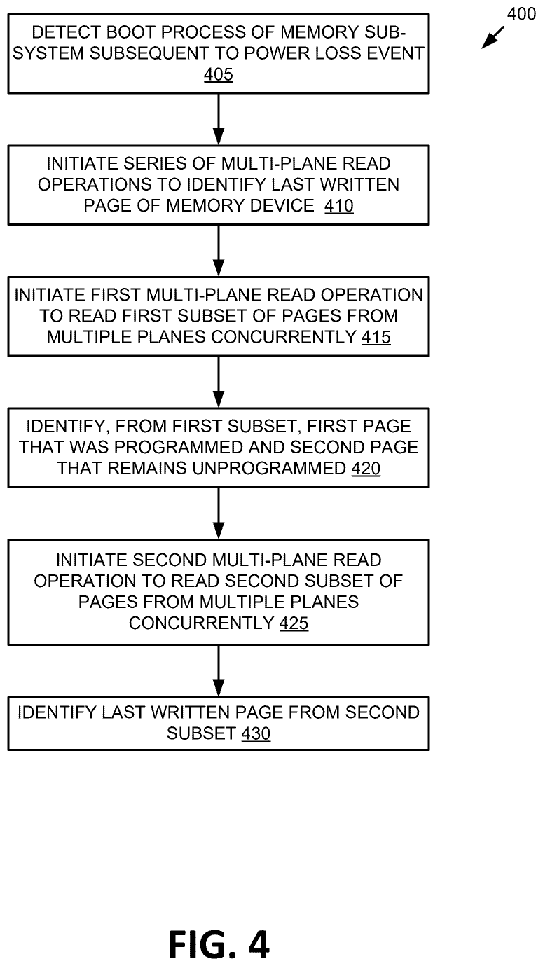

FIG. 4 is a flow diagram of an example method of performing a series of multi-plane read operations to identify a last written page in a multi-plane memory device in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by memory interface 113 of memory sub-system controller 115, in conjunction with local media controller 135, of FIG. 1A and FIG. 1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, a boot process is detected. For example, the processing logic can detect a boot process of the memory sub-system 110 subsequent to an occurrence of a power loss event. Depending on the embodiment, the power loss event can include one of a planned power down event or a sudden power loss event. In a planned power down event, the memory sub-system 110 may go through a normal power-down procedure (e.g., in response to a user command or a scheduled power down operation). In a sudden power loss event, the loss of power may be unexpected and the memory sub-system 110 may not be able to complete the full power-down procedure. Regardless of the type of power loss event, once power is restored, the processing logic may initiate a boot process to restore the memory sub-system 110 and resume operations.

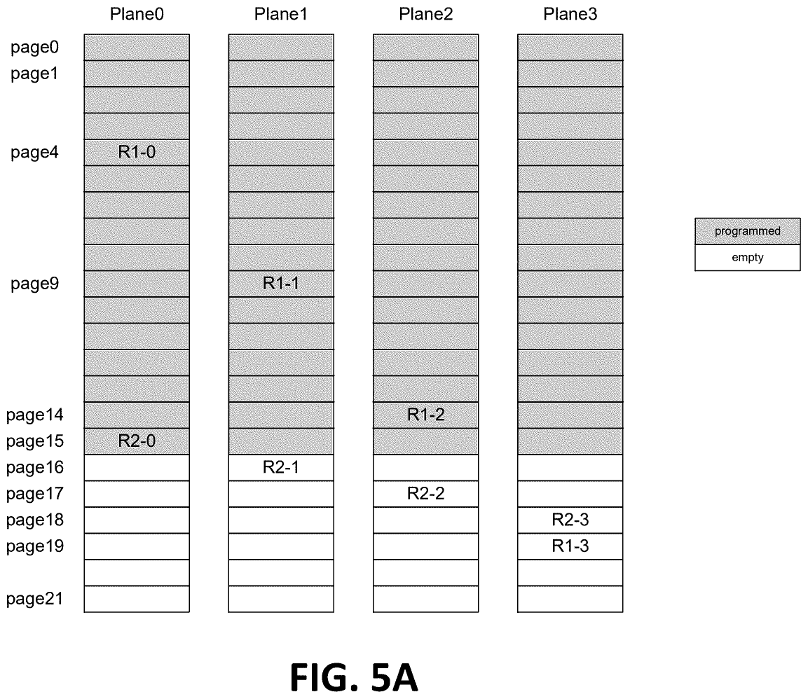

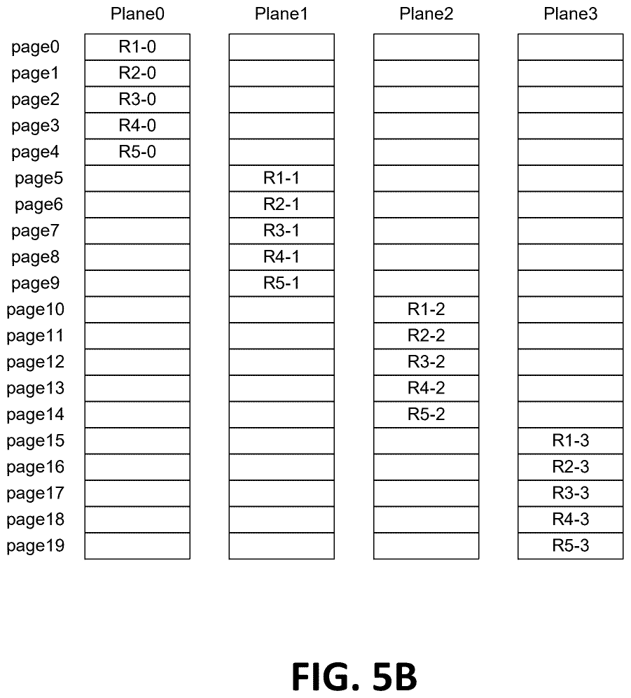

At operation 410, a series of multi-plane read operations are initiated. For example, the processing logic can initiate a series of multi-plane read operations to identify a last written page of a memory device, such as memory device 130, of the memory sub-system 110. In the event that memory interface 113 was performing a program operation on memory device 130 before the power loss event occurred, a portion of the memory device 130 may have been programmed, while a portion of the memory device 130 remains unprogrammed. In one embodiment, as illustrated in FIG. 5A, the memory device may include a number of planes (i.e., Plane0-Plane3) and each plane may be programmed sequentially (e.g., from page0-page21). In FIG. 5A, a portion of the memory device has been programmed (i.e., the shaded boxes representing page0-page15), while a portion of the memory device remains unprogrammed (i.e., the unshaded boxes representing page16-page21). Thus, in the illustrated example, the last written page on each of Plane0-Plane3 is page15, which was programmed prior to the occurrence of the power loss event. The processing logic can perform the series of multi-plane read operations to identify this last written page so that the program operation can be resumed at the correction location, as will be described in more detail below. In one embodiment, to initiate the series of multi-plane read operations, the processing logic can send one or more memory access commands to the control logic of the memory device 130 (e.g., local media controller 135). In response, the control logic may cause a plurality of independent plane driver circuits (e.g., driver circuits 374(0)-374(3) and/or page buffers 376(0)-376(3)) to read respective segments of Plane0-Plane3 concurrently.

At operation 415, a first multi-plane read operation is initiated. For example, as part of the series of multi-plane read operations, the processing logic can initiate a first multi-plane read operation to read a first subset of pages from the plurality of planes concurrently. In one embodiment, the first subset of pages comprises a different page on each of the plurality of planes. An example is illustrated in FIG. 5A. The processing logic can perform the multi-plane read operation to read a first subset of pages including page4 (i.e., R1-0) from Plane0, page9 (i.e., R1-1) from Plane1, page14 (i.e., R1-2) from Plane2, and page19 (i.e., R1-3) from Plane3. As illustrated in this example, the first subset of pages includes a different page from each plane, and the pages are spread out across the total number of pages (i.e., 22) in this memory array. The manner in which the first subset of pages are selected can vary depending on the implementation, although the processing logic may attempt to spread them out evenly (i.e., with an equal number of pages between each page in the first subset). Upon reading the pages in the first subset, the processing logic can determine whether each page in the first subset is either programmed (i.e., contains data) or remains unprogrammed (i.e., is in an erased state).

At operation 420, the processing device identifies select pages. For example, the processing logic can identify, based on the first multi-plane read operation, a first page from the first subset of pages that was programmed prior to the occurrence of the power loss event and a second page from the first subset of pages that remains unprogrammed. The first page and the second page can be sequential pages among those in the first subset of pages. Referring again to the example of FIG. 5A, page19 (i.e., R1-3) was unprogrammed, and thus could be the second page. If there were multiple unprogrammed pages among the first subset, the processing logic can select the lowest numbered unprogrammed page as the second page. Among the pages in the first subset, the previously sequential page that was programmed is page14 (i.e., R1-2), and thus could be the first page. The planes from which the first and second pages are read is immaterial. In some embodiments, during the first multi-plane read operation, either all of the pages or none of the pages in the first subset may have been programmed. These edge cases can be handled accordingly, as described below.

At operation 425, a second multi-plane read operation is initiated. For example, as part of the series of multi-plane read operations, the processing logic can a second multi-plane read operation to read a second subset of pages from the plurality of planes concurrently. In one embodiment, the second subset of pages comprises a different page on each of the plurality of planes and are located between the first page and the second page identified at operation 420. Referring to FIG. 5A, the processing logic can perform the multi-plane read operation to read a second subset of pages including page15 (i.e., R2-0) from Plane0, page16 (i.e., R2-1) from Plane1, page17 (i.e., R2-2) from Plane2, and page18 (i.e., R2-3) from Plane3. As illustrated in this example, the second subset of pages includes a different page from each plane, and the pages are located between page14 which was identified as a page that had already been programmed during the first multi-plane read operation (i.e., R1-2) and page19 which was identified as a page that remained unprogrammed during the first multi-plane read operation (i.e., R1-3). The manner in which the second subset of pages are selected can vary depending on the implementation, although the processing logic may attempt to spread them out evenly (i.e., with an equal number of pages between each page in the first subset). Upon reading the pages in the second subset, the processing logic can determine whether each page in the second subset is either programmed (i.e., contains data) or remains unprogrammed (i.e., is in an erased state). Depending on the number of pages in the block, the processing logic may repeat operations 420 and 425 some number of additional times, as needed.

At operation 430, a last written page is identified. For example, the processing logic can identify the last written page from those pages in the second subset of the plurality of pages. Referring to FIG. 5A again, since the pages in the second subset are sequential (i.e., page15-page18), and page15 (i.e., R2-0) was programmed and page16 (i.e., R2-1) was unprogrammed, no further read operations are needed. The processing logic can identify page15 as the last written page in the memory device. Accordingly, the processing logic can resume a previous programming operation or initiate a new programming operation at the first unprogrammed (i.e., page16).

FIG. 5B is a block diagram illustrating an alternate use of independent parallel plane access in a multi-plane memory device using a series of multi-plane read operations in accordance with some embodiments of the present disclosure. As can be see in FIG. 5B, the memory device in this example includes 20 pages (i.e., page0-page19) spanning four planes (i.e., Plane0-Plane3). Using independent parallel plane access, as described herein, each page of the memory device can be scanned in fewer read operations that a convention approach would require. By performing a series of multi-plane read operations, where each operation reads a different page from each plane, the entire memory device can be scanned in only five read operations, rather than 20. For example, a first multi-plane read operation can read page0 (i.e., R1-0) from Plane0, page5 (i.e., R1-1) from Plane1, page10 (i.e., R1-2) from Plane2, and page15 (i.e., R1-3) from Plane3. Similarly, a second multi-plane read operation can read page1 (i.e., R2-0) from Plane0, page6 (i.e., R2-1) from Plane1, page11 (i.e., R2-2) from Plane2, and page16 (i.e., R2-3) from Plane3. The remaining read operations can proceed in a similar manner until each page of the memory device has been read.

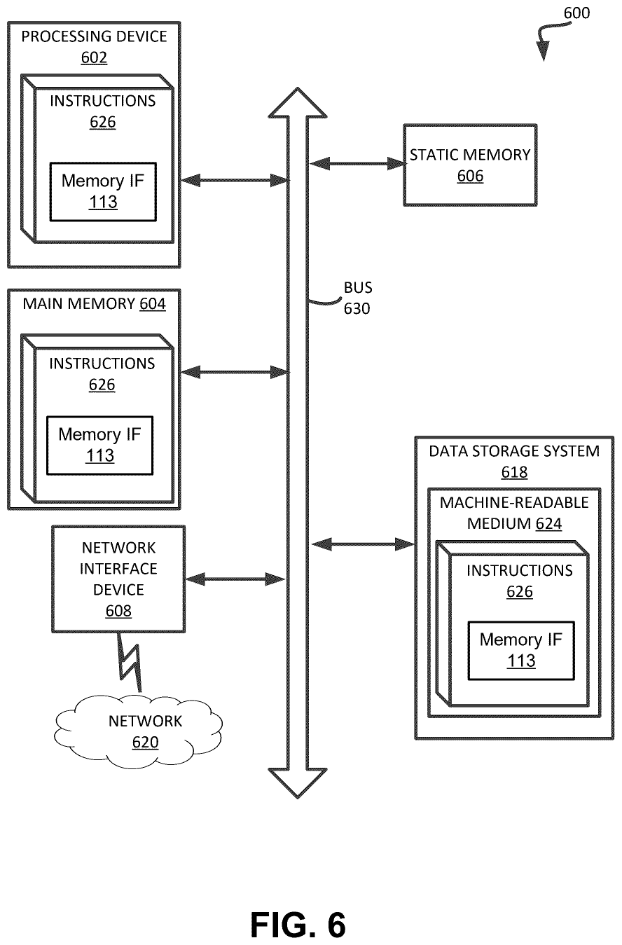

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to memory interface 113 or local media controller 135 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1A.

In one embodiment, the instructions 626 include instructions to implement functionality corresponding to the memory interface 113 of FIG. 1A. While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device comprising a memory array comprising a plurality of planes; and
a processing device, operatively coupled with the memory device, to perform operations comprising:
detecting a boot process of the system subsequent to an occurrence of a power loss event; and
initiating a series of multi-plane read operations to identify a last written page of the memory device, wherein the last written page was programmed prior to the occurrence of the power loss event, and wherein at least a portion of the memory device remains unprogrammed.

2. The system of claim 1, wherein the power loss event comprises at least one of a planned power down event or a sudden power loss event.

3. The system of claim 1, wherein the memory device further comprises:
a plurality of independent plane driver circuits operatively coupled with the plurality of planes; and
control logic operatively coupled with the plurality of independent plane driver circuits and with the plurality of planes.

4. The system of claim 3, wherein initiating the series of multi-plane read operations comprises:
sending one or more memory access commands to the control logic of the memory device, the control logic to cause the plurality of independent plane driver circuits to read respective segments of the plurality planes concurrently.

5. The system of claim 1, wherein initiating the series of multi-plane read operations comprises:
initiating a first multi-plane read operation to read a first subset of pages from the plurality of planes concurrently, wherein the first subset of pages comprises a different page on each of the plurality of planes.

6. The system of claim 5, wherein initiating the series of multi-plane read operations further comprises:
identifying, based on the first multi-plane read operation, a first page from the first subset of pages that was programmed prior to the occurrence of the power loss event and a second page from the first subset of pages that remains unprogrammed.

7. The system of claim 6, wherein initiating the series of multi-plane read operations further comprises:
initiating a second multi-plane read operation to read a second subset of pages from the plurality of planes concurrently, wherein the second subset of pages comprises a different page on each of the plurality of planes, and wherein the second subset of pages are located between the first page and the second page.

8. A method comprising:
detecting a boot process of a memory sub-system subsequent to an occurrence of a power loss event, the memory sub-system comprising a memory device comprising a plurality of planes; and
initiating a series of multi-plane read operations to identify a last written page of the memory device, wherein the last written page was programmed prior to the occurrence of the power loss event, and wherein at least a portion of the memory device remains unprogrammed.

9. The method of claim 8, wherein the power loss event comprises at least one of a planned power down event or a sudden power loss event.

10. The method of claim 8, wherein the memory device further comprises:
a plurality of independent plane driver circuits operatively coupled with the plurality of planes; and
control logic operatively coupled with the plurality of independent plane driver circuits and with the plurality of planes.

11. The method of claim 10, wherein initiating the series of multi-plane read operations comprises:
sending one or more memory access commands to the control logic of the memory device, the control logic to cause the plurality of independent plane driver circuits to read respective segments of the plurality planes concurrently.

12. The method of claim 8, wherein initiating the series of multi-plane read operations comprises:
initiating a first multi-plane read operation to read a first subset of pages from the plurality of planes concurrently, wherein the first subset of pages comprises a different page on each of the plurality of planes.

13. The method of claim 12, wherein initiating the series of multi-plane read operations further comprises:
identifying, based on the first multi-plane read operation, a first page from the first subset of pages that was programmed prior to the occurrence of the power loss event and a second page from the first subset of pages that remains unprogrammed.

14. The method of claim 13, wherein initiating the series of multi-plane read operations further comprises:
initiating a second multi-plane read operation to read a second subset of pages from the plurality of planes concurrently, wherein the second subset of pages comprises a different page on each of the plurality of planes, and wherein the second subset of pages are located between the first page and the second page.

15. A non-transitory computer-readable storage medium storing instructions which, when executed by a processing device, cause the processing device to perform operations comprising:
detecting a boot process of a memory sub-system subsequent to an occurrence of a power loss event, the memory sub-system comprising a memory device comprising a plurality of planes; and
initiating a series of multi-plane read operations to identify a last written page of the memory device, wherein the last written page was programmed prior to the occurrence of the power loss event, and wherein at least a portion of the memory device remains unprogrammed.

16. The non-transitory computer-readable storage medium of claim 15, wherein the power loss event comprises at least one of a planned power down event or a sudden power loss event.

17. The non-transitory computer-readable storage medium of claim 15, wherein the memory device further comprises:
a plurality of independent plane driver circuits operatively coupled with the plurality of planes; and
control logic operatively coupled with the plurality of independent plane driver circuits and with the plurality of planes.

18. The non-transitory computer-readable storage medium of claim 17, wherein initiating the series of multi-plane read operations comprises:
sending one or more memory access commands to the control logic of the memory device, the control logic to cause the plurality of independent plane driver circuits to read respective segments of the plurality planes concurrently.

19. The non-transitory computer-readable storage medium of claim 15, wherein initiating the series of multi-plane read operations comprises:
initiating a first multi-plane read operation to read a first subset of pages from the plurality of planes concurrently, wherein the first subset of pages comprises a different page on each of the plurality of planes; and
identifying, based on the first multi-plane read operation, a first page from the first subset of pages that was programmed prior to the occurrence of the power loss event and a second page from the first subset of pages that remains unprogrammed.

20. The non-transitory computer-readable storage medium of claim 19, wherein initiating the series of multi-plane read operations further comprises:
initiating a second multi-plane read operation to read a second subset of pages from the plurality of planes concurrently, wherein the second subset of pages comprises a different page on each of the plurality of planes, and wherein the second subset of pages are located between the first page and the second page.
